(19) United States
(12) Patent Application Publication
(10) Pub. No.: US 2015/0061249 A1
(43) Pub. Date: Mar. 5, 2015

(54) ATTACHMENT DEVICE

(71) Applicant: Raniel Diaz, Corona Del Mar, CA (US)

(72) Inventor: Raniel Diaz, Corona Del Mar, CA (US)

(21) Appl. No.: 14/455,687

(22) Filed: Aug. 8, 2014

Related U.S. Application Data
(60) Provisional application No. 61/863,845, filed on Aug. 8, 2013.

(51) Int. Cl. B62B 9/28; B62B 9/12

(52) U.S. Cl. CPC B62B 9/28; B62B 9/12
USPC 280/47.35

(57) ABSTRACT

The present disclosure relates to attachment device useful for adding an accessory to a wheeled seating device such as a stroller or a wheelchair. In one embodiment, the accessory is an additional seat.

### CROSS REFERENCE TO RELATED APPLICATIONS

This application claims the benefit of U.S. provisional patent application No. 61/863,845, filed Aug. 8, 2013, the entire disclosure of which is incorporated herein by reference.

### FIELD

The present specification relates to accessory attachment devices for strollers. Such accessory attachment devices can allow additional seats to be added to existing strollers.

### BACKGROUND

Parents who have children tend to acquire a wide variety of equipment for transporting their children from place to place. In particular, many parents have purchased strollers, stem mountable child seats, car seats, or baby carriers. When parents have their first child they typically purchase items for one child such as, for example, a single stroller, a stem mountable child seat, a baby carrier, and a car seat. Often, a second child follows and in response, parents dispose of old single child strollers and buy additional and/or new equipment to transport both children around. For example, a single stroller is often replaced with a double stroller making it possible to transport both children around at the same time.

### SUMMARY

Aspects disclosed herein comprise devices for attaching at least one accessory to a stroller. In one embodiment, an accessory can include an additional seat. An accessory attachment system can include a stroller, at least one additional seat, and an attachment device. The attachment device securely connects a stroller and a mountable seat together converting a stroller into a stroller plus one seat. Further aspects include a support tube, such as to provide at least one attachment point to the stroller. Additional aspects comprise at least one attachment tube, such as to provide at least one attachment point for an additional seat. In one embodiment, the additional seat is a mountable seat.

Embodiments disclosed herein include at least one support tube, which can attach to the headset/head tube assembly of strollers. The embodiment can further include at least one clamp that can be attached to the support tube. Other embodiments disclosed herein comprise an attachment point on the attachment device for a seat support member which can attach an additional seat. Further embodiments can include an attachment tube, which can be attached to the support tube. In some embodiments, the support tube can rotate freely with a stroller's fork tube, while allowing the attachment tube to remain stationary. In other embodiments, the additional seat and/or other accessory is stationary. Other embodiments can comprise one or more anti-rotation appendages for providing at least one attachment point to the stroller or the stroller's frame. Some embodiments can include one or more anti-rotation appendages, which can be connected to the attachment tube such as to provide the ability for front wheel(s) of a stroller to swing or rotate freely while keeping the additional seat and/or accessory stationary.

Still other embodiments disclosed herein comprise at least one accessory appendage, which at least one accessory can be attached. In one embodiment, the accessory can be an electronic accessory such as, but not limited to a tablet or smart phone.

### BRIEF DESCRIPTION OF THE DRAWINGS

FIG. 1 illustrates a perspective view of an additional seat added to a stroller as disclosed herein.

FIG. 2 illustrates a partially exploded view of FIG. 1 with the additional seat removed.

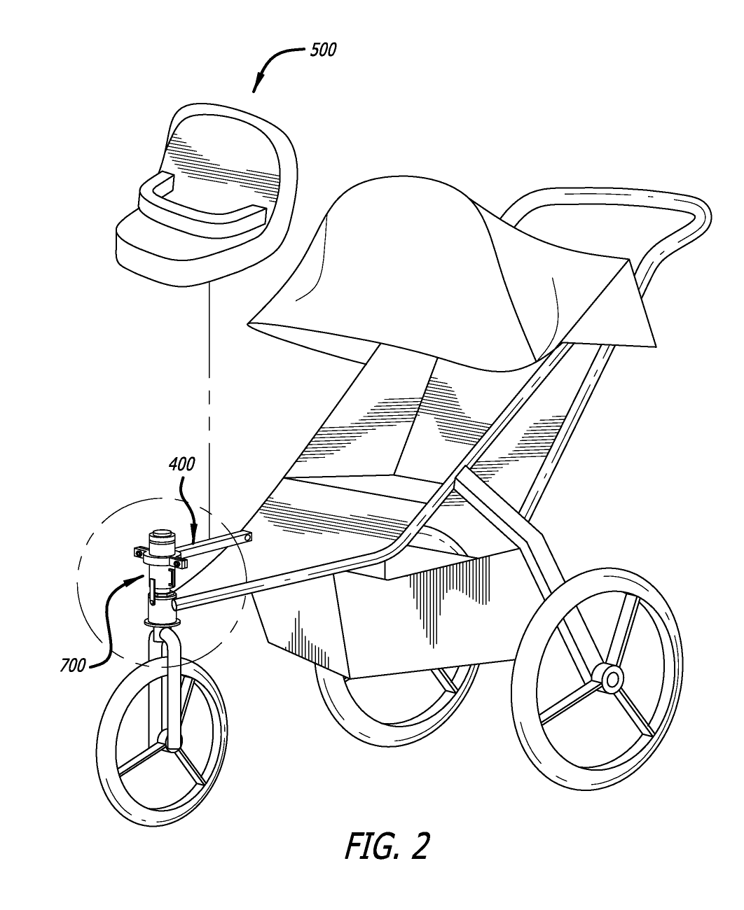

FIG. 3 illustrates a detailed view of embodiments of anti-rotation appendages from FIG. 1.

FIG. 4A illustrates an exploded view of a mounting apparatus as disclosed herein. FIG. 4B illustrates an exploded view of another mounting apparatus.

FIG. 5 illustrates a side view of a seat added to a stroller as disclosed herein.

FIG. 6 illustrates a view of an electronic accessory attached to a stroller as disclosed herein.

FIG. 7A illustrates a cross-sectional view of an embodiment as disclosed herein.

FIG. 7B illustrates a cross-sectional view of an additional embodiment as disclosed herein.

### DETAILED DESCRIPTION

Disclosed herein are apparatus, systems, and methods for attaching accessories to wheeled seating devices such as wheel chairs or strollers. In some embodiments, the apparatus and systems include an attachment device which can be configured to connect one or more accessories to a stroller. In one embodiment, the attachment device can provide an accessory attachment point to a stroller.

An accessory can include, but is not limited to an additional and/or mountable seat, a cup holder, a basket, a cooling fan, a heating fan, a mister fan, a storage bucket, an electronic device, a cooler, a trash can, a clip, and the like. Mountable seats can include bike stem mountable child seats and/or rear bike mountable child seats. Electronic devices can include, but are not limited to tablets, portable DVD players, electronic ready devices, computers, cellular phones, smart phones, MP3 players, and the like.

In one embodiment, an attachment device can provide an attachment point for a mountable seat. In some embodiments, attachment device can be directed to an attachment device for a stroller capable of supporting a seat such as, for example, a stem mountable child seat, or a rear mountable child seat.

In some embodiments, the attachment device can be configured, for example, to alter or adjust its size or shape to accommodate different styles and sizes of strollers and/or accessories. Additional embodiments of attachment devices comprise an appendage which an accessory or accessories can be mounted. Additionally, the embodiments of appendage can be directed to attachment of an electronic device.

Embodiments of attachment device can be capable of converting a single stroller into a double stroller. Double strollers can be substantially larger than single strollers and are therefore more difficult to maneuver. Additionally, a double stroller may occupy more real-estate within a house or car than a single stroller. The benefit of being able to accommodate both children with a single device outweighs these disadvantages. However, when parents only have one child with them, the benefits of having a double stroller is not realized or even wasted. Parents often keep a single stroller to accommodate times when only one child is transported. Therefore, parents can have both a single and a double stroller occupying more real-estate within their car's trunk or living area.

“Anti-rotation appendage” as used herein refers to any type of appendage that can be connected from any portion of the attachment device to any portion of a stroller to stop a mounted seat from rotating.

“Attachment tube” as used herein refers to a tube or pipe that can attach to a seat, an accessory appendage, and/or an anti-rotation appendage.

“Clamp” as used herein refers to a device that can secure an attachment device in a fixed position.

“Fork tube” as used herein can connect a stroller's front wheel or wheels to its frame. Typical strollers have either fixed front wheels, front wheels that rotate freely while being pushed, or front wheels that can be locked and unlocked to allow for rotation.

“Headset” as used herein refers to a set of components that can provide a rotatable interface between an attachment tube and a support tube of an attachment device, and between a head tube and a stroller's fork tube. Headsets can include at least two cups that are pressed into the top and bottom of the head tube. Inside the cups are bearings which can provide a low friction contact between a cup (e.g., a bearing cup) and a stroller's fork tube.

“Head tube” as used herein refers to the short tubular frame of a stroller which the stroller's fork tube passes through. A head tube can be called the steering head. The head tube can contain at least one headset.

“Interference fit” or “press fit” or “friction fit” as used herein refers to fastening two parts together by the use of friction. The friction that holds the parts together are increased by the compression of one part against the other, which relies on the tensile strength and compressive strength of the materials the parts are made from.

“Mountable seat” as used herein refers to any type of seat that is capable of being secured or mounted to or onto a bicycle or other type of mobile device.

“Peg in hole” as used herein refers to a shaft or pin that is inserted into a hole to secure a device into place.

“Releasably connected” or “releasably attached” as used herein refers to a connection that is not permanent and/or is capable of easily being released without the aid of any special tools or special skills.

“Stroller” as used herein refers to any pushable wheeled device which can be used to transport a mammal. In one embodiment, the mammal can be a human child.

“Stroller fork” as used herein refers to the stroller portion that holds the front wheel(s) and allows a parent to steer the stroller. A fork can include two blades which join at a fork crown, and a steerer or fork tube.

“Support tube” as used herein refers to at least one tube that can be inserted into a stroller's headset, support the attachment tube, and/or support at least one additional appendage.

Embodiments disclosed herein comprise an additional seat attachment device for adding at least one additional seat to a stroller. A system can include a stroller or other wheeled device, a mountable or other additional seat, and an attachment device.

Strollers can include, but not limited to, jogging strollers, travel strollers, full-size strollers, all-terrain strollers, frame strollers, double strollers, triple strollers, strollers with one or two front wheels, or the like. In one embodiment, the stroller is a BOB® (Fort Mill, S.C.) series stroller such as but not limited to Revolution, Revolution SE, Strides Fitness Stroller, Stroller Strides Duallie, Motion, Ironman, Sport Utility, or Sport Utility Duallie.

Additional seats to be mounted can be for example, front stem mountable seats, back stem mountable seats, infant car seats, convertible car seats, or the like. Embodiments of the attachment device may be capable of converting any style of stroller. In one embodiment, a single stroller can be converted into a double stroller and/or stroller plus three, plus four, plus five, additional seats seat stroller. Further, in other embodiments, a double stroller can be converted into a triple stroller, a triple stroller into a quad stroller, and the like.

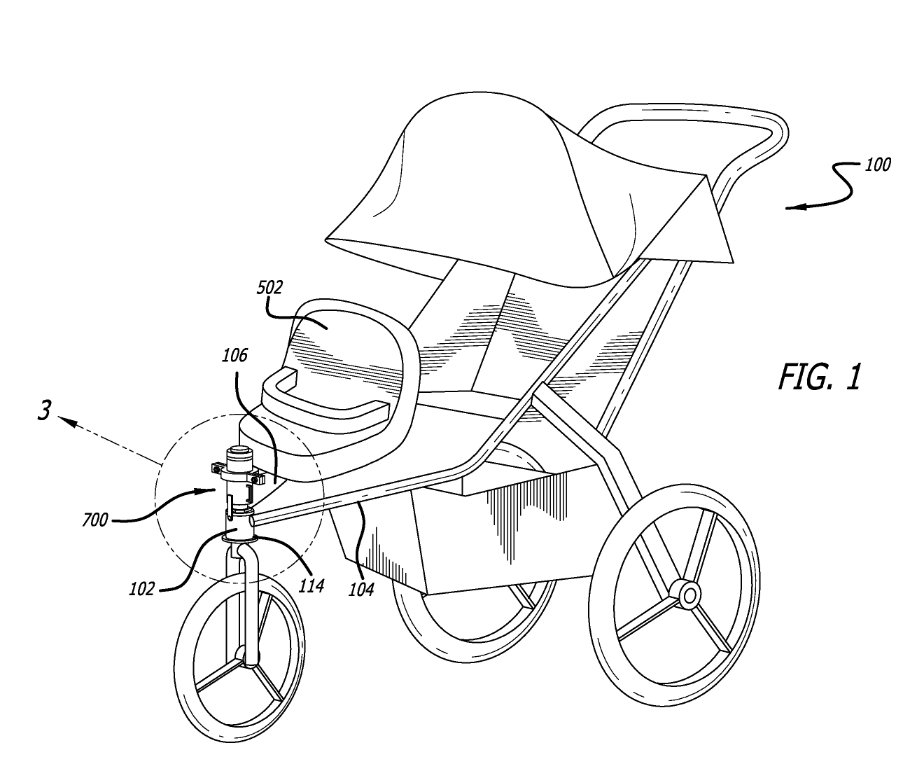

An example stroller system is illustrated in FIG. 1 as plus one stroller 100. Stroller 100 includes first frame member 104 and second frame member 106 that can be attached to head tube 102. Head tube 102 can provide an attachment point for attachment device 700 to be secured to head tube 102. Stroller 100 is shown only as an example of one type of stroller that can be used. The frame of the stroller may be any of many possible configurations. Embodiments of the attachment device may be configured to be used on any such configuration of a stroller. For example, a different embodiment of the stroller may include two, three, four, five, or more front wheels, and may include one or more folding mechanism. In addition, the stroller may include additional features such as for example, a fixed front wheel or wheels, an entirely different frame configuration, or storage space beneath the seat of the stroller. In other embodiments, a wheelchair may be used in place of a stroller.

In some embodiments the head tube 102 has an outer diameter 114. Outer diameter 114 can be, at least about ¼ inch, at least about ½ inch, at least about ¾ inch, at least about ⅞ inch, at least about 1 inch, at least about 1⅛ inches, at least about 1 ¼ inches, at least about 1½ inches, at least about 1⅝ inches, at least about 1¾ inches, at least about 2 inches, about ¼ inch, about ½ inch, about ¾ inch, about ⅞ inch, about 1 inch, about 1⅛ inches, about 1¼ inches, about 1½ inches, about 1⅝ inches, about 1¾ inches, about 2 inches, at most about ¼ inch, at most about ½ inch, at most about ¾ inch, at most about ⅞ inch, at most about 1 inch, at most about 1⅛ inches, at most about 1¼ inches, at most about 1½ inches, at most about 1⅝ inches, at most about 1¾ inches, at most about 2 inches, between about ¼ inch to about 1 inch, between about ¼ inch to about 2 inches, between about ½ inch to about 1 inch, between about ½ to about 2 inches, between about ¾ inch to about 1 inch, between about ¾ inch to about 2 inches, between about ⅞ inch to about 1 inch, between about ⅞ inch to about 2 inches, between about 1 inch to about 2 inches, between about 1¼ inches to about 2 inches, between about 1½ inches to about 2 inches, between about 1⅝ inches to about 2 inches, between about 1¾ inches to about 2 inches, or the like.

Additionally, in some embodiments head tube 102 has an inner diameter 110. Inner diameter 110 can be, at least about ⅛ inch, ¼ inch, at least about ½ inch, at least about ¾ inch, at least about ⅞ inch, at least about 1 inch, at least about 1⅛ inches, at least about 1¼ inches, at least about 1½ inches, at least about 1⅝ inches, at least about 1¾ inches, at least about 2 inches, about ¼ inch, about ½ inch, about ¾ inch, about ⅞ inch, about 1 inch, about 1⅛ inches, about 1¼ inches, about 1½ inches, about 1⅝ inches, about 1¾ inches, about 2 inches, at most about ¼ inch, at most about ½ inch, at most about ¾ inch, at most about ⅞ inch, at most about 1 inch, at most about 1⅛ inches, at most about 1¼ inches, at most about 1½ inches, at most about 1⅝ inches, at most about 1¾ inches, at most about 2 inches, between about ⅛ inch and about 2 inches, between about ¼ inch to about 1 inch, between about ¼ inch to about 2 inches, between about ½ inch to about 1 inch, between about ½ to about 2 inches, between about ¾ inch to about 1 inch, between about ¾ inch to about 2 inches, between about ⅞ inch to about 1 inch, between about ⅞ inch to about 2 inches, between about 1 inch to about 2 inches, between about 1¼ inches to about 2 inches, between about 1½ inches to about 2 inches, between about 1⅝ inches to about 2 inches, between about 1¾ inches to about 2 inches, or the like.

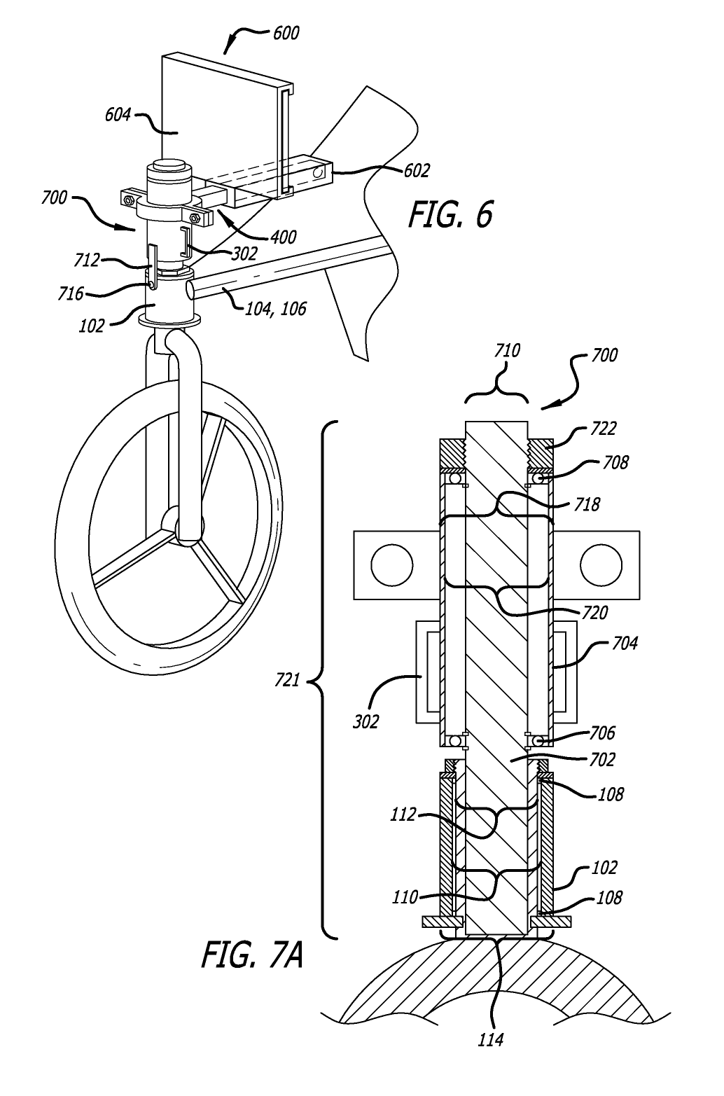

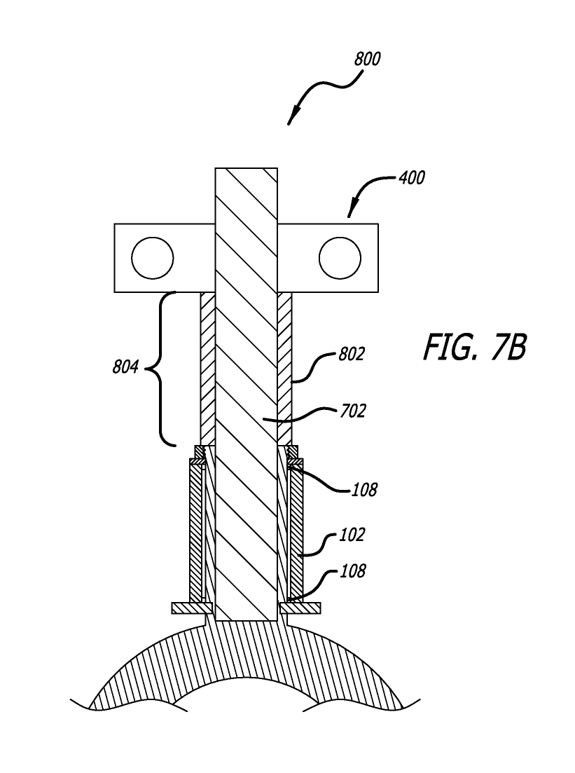

In some embodiments support tube 702 can have an outer diameter 710 that is smaller then inner diameter 110 of head tube 102 as illustrated in FIG. 7A. For example, outer diameter 710 can be, at least about ⅛ inch, ¼ inch, at least about ½ inch, at least about ¾ inch, at least about ⅞ inch, at least about 1 inch, at least about 1⅛ inches, at least about 1¼ inches, at least about 1½ inches, at least about 1⅝ inches, at least about 1¾ inches, at least about 2 inches, about ¼ inch, about ½ inch, about ¾ inch, about ⅞ inch, about 1 inch, about 1⅛ inches, about 1¼ inches, about 1½ inches, about 1⅝ inches, about 1¾ inches, about 2 inches, at most about ¼ inch, at most about ½ inch, at most about ¾ inch, at most about ⅞ inch, at most about 1 inch, at most about 1⅛ inches, at most about 1¼ inches, at most about 1½ inches, at most about 1⅝ inches, at most about 1¾ inches, at most about 2 inches, between about ⅛ inch and about 2 inches, between about ¼ inch to about 1 inch, between about ¼ inch to about 2 inches, between about ½ inch to about 1 inch, between about ½ to about 2 inches, between about ¾ inch to about 1 inch, between about ¾ inch to about 2 inches, between about ⅞ inch to about 1 inch, between about ⅞ inch to about 2 inches, between about 1 inch to about 2 inches, between about 1¼ inches to about 2 inches, between about 1½ inches to about 2 inches, between about 1⅝ inches to about 2 inches, between about 1¾ inches to about 2 inches, or the like.

In some embodiments, as illustrated in FIG. 7A, the stroller's headset 108 can accommodate tube sizes 112 for example, at least about ⅛ inch, 1/4 inch, at least about ½ inch, at least about ¾ inch, at least about ⅞ inch, at least about 1 inch, at least about 1⅛ inches, at least about 1¼ inches, at least about 1½ inches, at least about 1⅝ inches, at least about 1¾ inches, at least about 2 inches, about ¼ inch, about ½ inch, about ¾ inch, about ⅞ inch, about 1 inch, about 1⅛ inches, about 1¼ inches, about 1½ inches, about 1⅝ inches, about 1¾ inches, about 2 inches, at most about ¼ inch, at most about ½ inch, at most about ¾ inch, at most about ⅞ inch, at most about 1 inch, at most about 1⅛ inches, at most about 1¼ inches, at most about 1½ inches, at most about 1⅝ inches, at most about 1¾ inches, at most about 2 inches, between about ⅛ inch and about 2 inches, between about ¼ inch to about 1 inch, between about ¼ inch to about 2 inches, between about ½ inch to about 1 inch, between about ½ to about 2 inches, between about ¾ inch to about 1 inch, between about ¾ inch to about 2 inches, between about ⅞ inch to about 1 inch, between about ⅞ inch to about 2 inches, between about 1 inch to about 2 inches, between about 1¼ inches to about 2 inches, between about 1½ inches to about 2 inches, between about 1⅝ inches to about 2 inches, between about 1¾ inches to about 2 inches, or the like.

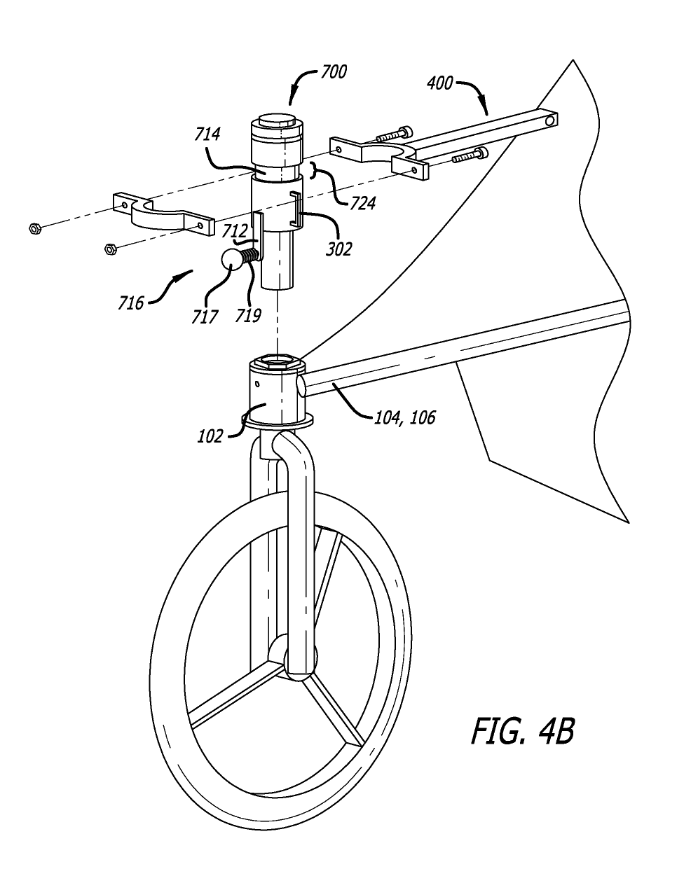

As illustrated in FIG. 5, embodiments of mountable seat system 500 comprise mountable seat 502, seat support member 400 for attachment to attachment device 700. Attachment device 700 can be, for example, u-bolts, t-bars, threadless handlebar adapters, stinger seat mounts, universal bracket, or the like. An embodiment of mountable seat system 500 is shown only as an example of one type of mountable seat that can be used. Seat support member 400 may be any configuration capable of supporting a mountable seat. For Embodiments of seat support member 400 may be configured to be any of many possible mountable seat configurations. Additionally, another embodiment of the seat support member can be used with a baby seat or a car seat. In one embodiment, any configuration that can be used supports the attachment of a seat. In one embodiment, mountable seat 502 is a bike mountable seat. In other embodiments, mountable seat 502 is an IBERT® (Cody, Wyo.) safe-T-seat.

In some embodiments at least one clamp 722 can accommodate support tube 702 outer diameter size such as, for example, at least about ⅛ inch, ¼ inch, at least about ½ inch, at least about ¾ inch, at least about ⅞ inch, at least about 1 inch, at least about 1⅛ inches, at least about 1¼ inches, at least about 1½ inches, at least about 1⅝ inches, at least about 1¾ inches, at least about 2 inches, about ¼ inch, about ½ inch, about ¾ inch, about ⅞ inch, about 1 inch, about 1⅛ inches, about 1¼ inches, about 1½ inches, about 1⅝ inches, about 1¼ inches, about 2 inches, at most about ¼ inch, at most about ½ inch, at most about ¼ inch, at most about ⅞ inch, at most about 1 inch, at most about 1⅛ inches, at most about 1¼ inches, at most about 1½ inches, at most about 1⅝ inches, at most about 1¼ inches, at most about 2 inches, between about ⅛ inch and about 2 inches, between about ¼ inch to about 1 inch, between about ¼ inch to about 2 inches, between about ½ inch to about 1 inch, between about ½ to about 2 inches, between about ¼ inch to about 1 inch, between about ¼ inch to about 2 inches, between about ⅞ inch to about 1 inch, between about ⅞ inch to about 2 inches, between about 1 inch to about 2 inches, between about 1¼ inches to about 2 inches, between about 1 1/2 inches to about 2 inches, between about 1⅝ inches to about 2 inches, between about 1¼ inches to about 2 inches, or the like.

As illustrated in FIG. 1, stroller 100 can comprise a frame (e.g., frame 104,106) that supports an attachment device 700. The frame may, optionally, include head tube 102 and/or head set configurations. Attachment device 700 may be permanently affixed or releasably connected to stroller 100. Additionally, seat 502 may be permanently affixed or releasably connected to seat support member 400. Further, seat support member 400 may be permanently affixed or releasably connected to attachment device 700. In some embodiments, releasable connections can be for example, friction fittings, interference fits, threaded connections, locking tabs, keyed connections, quick release clamps, or the like.

In some embodiments support tube 702 can have a length 721. Length 721 can vary to accommodate different mountable seat support members 400 such as, for example, more than about 1 inch, more than about 2 inches, more than about 3 inches, more than about 4 inches, more than about 5 inches, more than about 6 inches, more than about 7 inches, more than about 8 inches, more than about 9 inches, more than about 10 inches, more than about 11 inches, more than about 1 foot, about 1 inch, about 2 inches, about 3 inches, about 4 inches, about 5 inches, about 6 inches, about 7 inches, about 8 inches, about 9 inches, about 10 inches, about 11 inches, about 1 foot, less than about 1 inch, less than about 2 inches, less than about 3 inches, less than about 4 inches, less than about 5 inches, less than about 6 inches, less than about 7 inches, less than about 8 inches, less than about 9 inches, less than about 10 inches, less than about 11 inches, less than about 1 foot, between about 1 inch and about 2 inches, between about 1 inch and about 3 inches, between about 2 inches and about 3 inches, between about 3 inches and about 5 inches, between about 4 inches and about 6 inches, between about 4 inches and about 7 inches, between about 5 inches and about 7 inches, between about 5 inches and about 8 inches, between about 6 inches and about 8 inches, between about 7 inches and about 9 inches, between about 8 inches and about 10 inches, between about 9 inches and about 11 inches, between about 10 inches and about 1 foot, or the like.

One example attachment device 700 is illustrated in FIG. 7A. Attachment device 700 can comprise support tube 702, which can be a cylindrical shape or substantially cylindrical. However, in other embodiments, support tube 702 may not be cylindrical in shape. Support tube 702 can be for example, a rod, a tube, a pipe, a shaft, a bar, or the like. Support tube 702 can be inserted and attached to cylindrical recess of headset member 108 of FIG. 7A. In some embodiments, support tube 702 can be attached to stroller's headset member 108, frame 104,106 or head tube 102 by, for example, interference fit, a threaded connection(s), clamped, keyed, welded, a locking nut(s), or the like. In some embodiments, attachment device 700 need not interface with head tube 102. Rather, in such an embodiment, appendages 302, and 304 can independently secure attachment device 700 to a stroller's frame.

In embodiments as shown in FIG. 7A, attachment tube 704 can have a cylindrical shape and be attached to support tube 702. Attachment tube 704 can be, for example, a rod, a tube, a pipe, a shaft, a bar, or the like. Attachment tube 704 can be secured to support tube 702 through first and second support members 706,708, which can be for example, bearings, headsets, washers, stand-offs, or the like. The first and second support members 706,708 can allow support tube 702 to substantially rotate freely with stroller's wheel, while allowing attachment tube 704 to remain substantially stationary with an anti-rotation appendage. In some embodiments attachment tube 704 can have an outer diameter 718, not more than about ½ inch, not more than about ¾ inch, not more than about ⅞ inch, not more than about 1 inch, not more than about 1⅛ inches, not more than about 1¼ inches, not more than about 1½ inches, not more than about 1⅝ inches, not more than about 1¾ inches, not more than about 2 inches, about ½ inch, about ¾ inch, about ⅞ inch, about 1 inch, about 1⅛ inches, about 1¼ inches, about ½ inches, about 1⅝ inches, about 1¾ inches, about 2 inches, not less than about ½ inch, not less than about ¾ inch, not less than about ⅞ inch, not less than about 1 inch, not less than about 1⅛ inches, not less than about 1¼ inches, not less than about ½ inches, not less than about 1⅝ inches, not less than about 1¾ inches, not less than about 2 inches, between about ¼ inch and about 1 inch, between about ¼ inch and about 2 inches, between about ½ inch and about 1 inch, between about ½ and about 2 inches, between about ¾ inch and about 1 inch, between about ¾ inch and about 2 inches, between about ⅞ inch and about 1 inch, between about ⅞ inch and about 2 inches, between about 1 inch and about 2 inches, between about 1¼ inches and about 2 inches, between about ½ inches and about 2 inches, between about 1⅝ inches and about 2 inches, between about 1¾ inches and about 2 inches, or the like.

In some embodiments attachment tube 704 can have an inner diameter 720 of, at least about ⅛ inch, ¼ inch, at least about ½ inch, at least about ¾ inch, at least about ⅞ inch, at least about 1 inch, at least about 1⅛ inches, at least about 1¼ inches, at least about ½ inches, at least about 1⅝ inches, at least about 1¾ inches, at least about 2 inches, about ¼ inch, about ½ inch, about ¾ inch, about ⅞ inch, about 1 inch, about 1⅛ inches, about 1¼ inches, about ½ inches, about 1⅝ inches, about 1¾ inches, about 2 inches, at most about ¼ inch, at most about ½ inch, at most about ¾ inch, at most about ⅞ inch, at most about 1 inch, at most about 1⅛ inches, at most about 1¼ inches, at most about ½ inches, at most about 1⅝ inches, at most about 1¾ inches, at most about 2 inches, between about ⅛ inch and about 2 inches, between about ¼ inch to about 1 inch, between about ¼ inch to about 2 inches, between about ½ inch to about 1 inch, between about ½ to about 2 inches, between about ¾ inch to about 1 inch, between about ¾ inch to about 2 inches, between about ⅞ inch to about 1 inch, between about ⅞ inch to about 2 inches, between about 1 inch to about 2 inches, between about 1¼ inches to about 2 inches, between about ½ inches to about 2 inches, between about 1⅝ inches to about 2 inches, between about 1¾ inches to about 2 inches, or the like.

As illustrated in FIG. 7A, in some embodiments, support tube 702 can be secured by clamp 722, yet allowing the support tube to substantially rotate, to the attachment tube 702 by for example, headsets, clamps, threaded nuts, welded, a press fit, or the like.

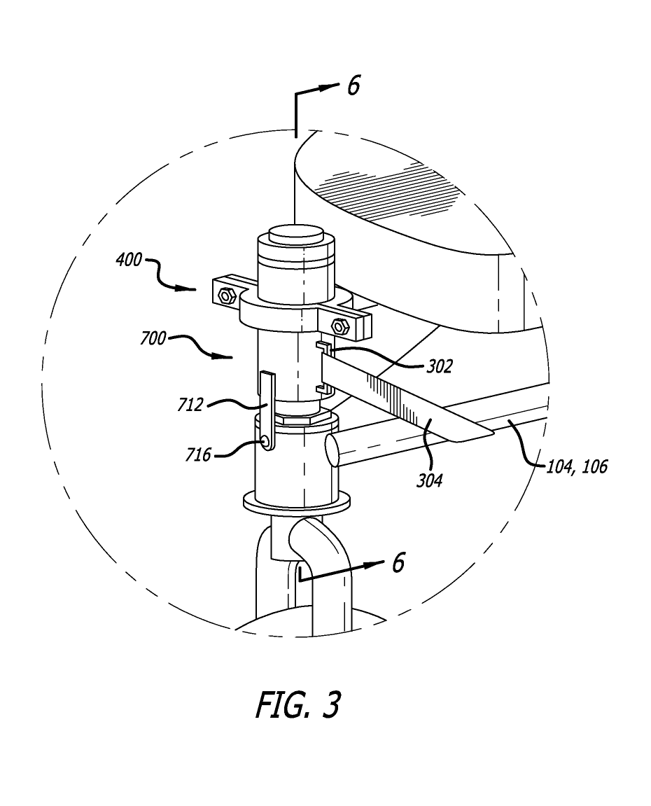

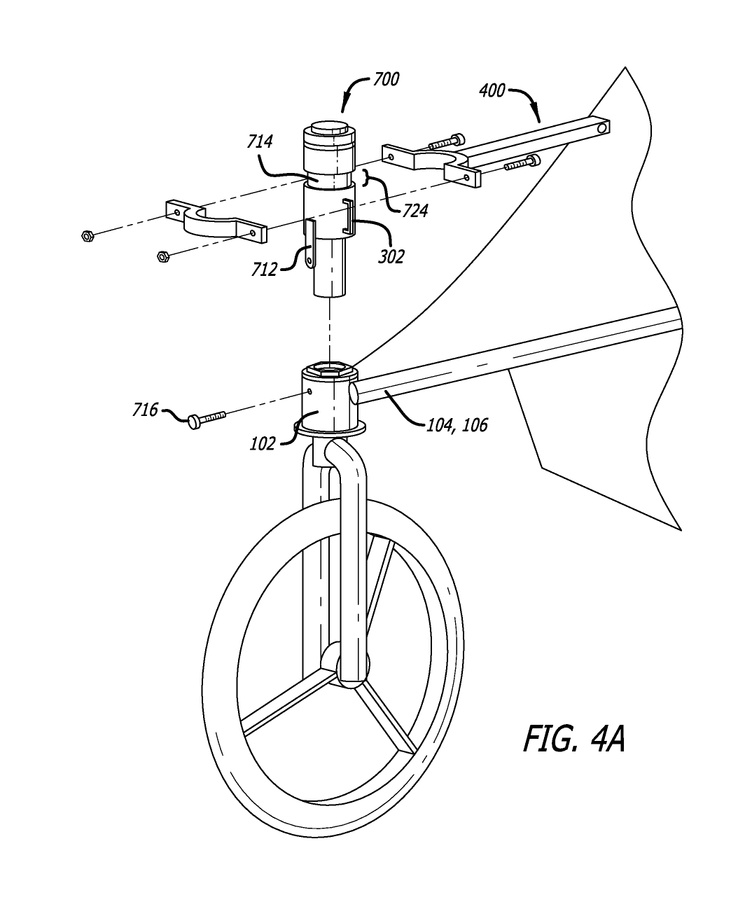

In some embodiments, attachment tube 704 can include one or more appendages 712, 302, and 304 as shown in FIG. 3 and FIGS. 4A and 4B. In one embodiment, appendages 712, 302, and 304 can be used for structural support. In other embodiments, appendages 712, 302, and 304 can be anti-rotation appendages.

In some embodiments, appendage 712 is an anti-rotation appendage and can be attached to head tube 102 and/or frame members 104 by a bolt or bolts 716 in for example, one location, two locations, three locations, four locations, five locations, or the like. In some embodiments, bolt or bolts 716 can be used as a safety device to anchor attachment device 700 to head tube 102. Bolt 716 for example can be threaded through appendage 712, through head tube 102 and into attachment device 700.

In another embodiment, as illustrated in FIG. 4B, bolt 716 can include a head portion 717 and a spring 719. Head portion 717 can be grasped and pulled in order to release attachment device 700 from head tube 102. Also, head portion 717 can be grasped and pulled in order to easily install attachment device 700. Further, spring can be attached to head portion 717 and appendage 712 in order to provide an integrated locking safety system.

Additionally, in other embodiments, tie-down rings can be used as anti-rotation appendages. In other embodiments, one or more appendage can be attached to the stroller's first and second frame members 104,106 to prevent rotation by, for example, tensioning slide with at least one hook and loop cinch strap, cable ties, webbing, fabric straps, wire tie downs, or the like. In some embodiments the hook and loop strap can comprise low-stretch polyester, abrasion-resistant nylon, polypropylene, or the like.

As illustrated in FIGS. 4A and 4B some embodiments of the attachment tube 704 can have a cylindrical groove 714 that may be utilized for attaching a mountable seat 502. In such an embodiment, the groove 714 may vary in length 724 to accommodate different attachment styles. In some embodiments the groove's length 724 can be for example, at least about 1 inch, at least about 2 inches, at least about 3 inches, at least about 4 inches, at least about 5 inches, at least about 6 inches, at least about 7 inches, about 1 inch, about 2 inches, about 3 inches, about 4 inches, about 5 inches, about 6 inches, about 7 inches, at most about 1 inch, at most about 2 inches, at most about 3 inches, at most about 4 inches, at most about 5 inches, at most about 6 inches, at most about 7 inches, between about 1 inch and about 2 inches, between about 1 inch and about 3 inches, between about 2 inches and about 4 inches, between about 3 inches and about 5 inches, between about 4 inches and about 6 inches, between about 5 inches and about 7 inches, between about 6 inches and about 7 inches, or the like. Additionally, in other embodiments the attachment tube 704 may not have a cylindrical groove.

As illustrated in FIG. 7B, the embodiment of the attachment device 800 comprises support tube 702, and spacer 802. Support tube 702 may be attached to the stroller's frame 104, or head tube 102 and headset 108. In some embodiments, support tube 702 can be attached by interference fit, threaded connection, clamped, keyed, quick release clamp, or the like.

Support tube 702 of this embodiment can have a substantially cylindrical shape. Support tube 702 can be, for example, a rod, a tube, a pipe, a shaft, a bar, or the like. The support tube 702 can be inserted and attached to cylindrical recess of headset 108. Headset 108 has a complimentary and cooperating shape that allows support tube 702 to be secured to headset 108. Attachment mechanisms that may be utilized include, but are not limited to, interference fit, threaded connection, clamped, keyed, or the like.

In FIG. 7B, attachment device 800 is shown connected to spacer 802. Spacer 802 can be, for example, a rod, a tube, a pipe, a shaft, a bar, or the like. Spacer 802 is substantially cylindrical in shape and can be inserted over and attached to the support tube 702 by for example, interference fit, threaded connection, clamped, keyed, or the like. In one embodiment, spacer 802 may vary in length to accommodate seats of different shapes and sizes. In some embodiments spacer 802 can have length 804. Length 804 can be for example, at least about 1 inch, at least about 2 inches, at least about 3 inches, at least about 4 inches, at least about 5 inches, about 1 inch, about 2 inches, about 3 inches, about 4 inches, about 5 inches, at most about 1 inch, at most about 2 inches, at most about 3 inches, at most about 4 inches, at most about 5 inches, between about 1 inch and about 2 inches, between about 1 inch and about 3 inches, between about 2 inches and about 3 inches, between about 2 inches and about 4 inches, between about 3 inches and about 5 inches, between about 4 inches and about inches, or the like.

In FIG. 7B attachment device 800 can be connected to seat support member 400. In FIGS. 4A and 4B, attachment device 700 is shown connected to one type of mounting bracket 400 as an example configuration. Attachment device 800 may be configured to be used on any such configuration of seat support member 400 and mountable seat 500.

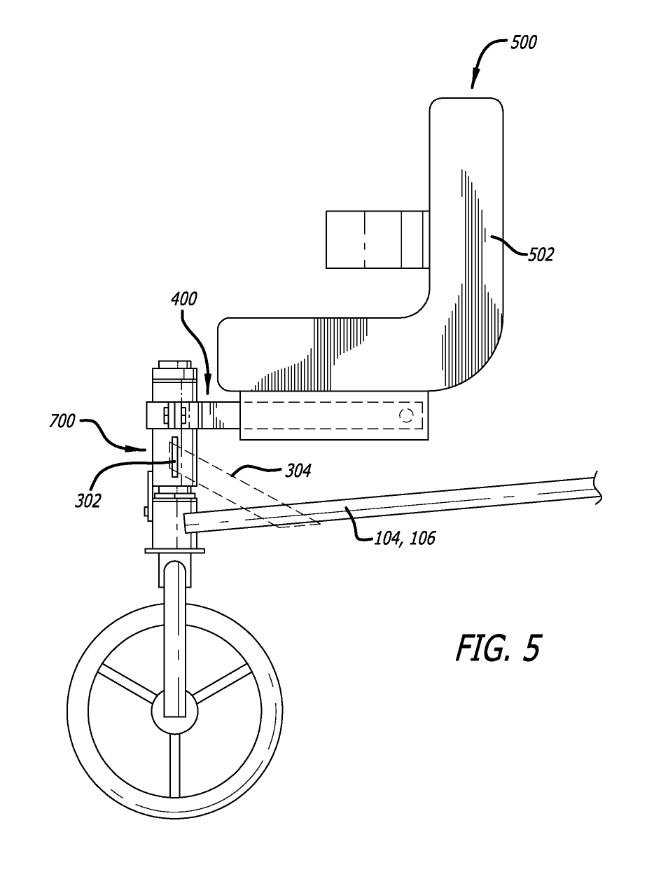

Another embodiment for an attachment device is shown in FIG. 6. The combination of attachment device 700 and support member 400 may be any configuration capable of supporting any type of accessory attachment 600. Accessory attachment can be an attachment comprising connector portion 602, and frame 604 that can support an accessory. Frame 604 can be independently adjustable in the vertical and/or horizontal directions. In other embodiments, frame 604 can be manufactured to specifically fit a particular device, such as a particular tablet. In another embodiment, frame may include a magnetic connection to an accompanying accessory case or can mate directly to a magnet within a device or to the metal casing on a device.

The accessory attachment 600 may be attached to the support member 400 allowing a child riding in the stroller or the adult pushing the stroller to watch or listen mounted accessories. Further accessory attachment 600 can include portion(s) formed of a bendable material such as a bendable metal, bendable metal coated in polymer, or the like. A bendable material can allow an attached accessory to be viewed at different angles or assume different orientations.

Though not illustrated in FIG. 6, additional embodiments of accessory attachment 600 can be adjustable in the vertical or horizontal directions, which can allow for adjustment for larger or smaller children who are riding within the stroller. Connector portion 602 may be such that it can be attached to any type of seat support member 400 such as for example, using u-bolts, t-bars, threadless handlebar adapters, stinger seat mounts, universal brackets, or the like.

### EXAMPLES

The following non-limiting examples are provided for illustrative purposes only in order to facilitate a more complete understanding of representative embodiments. These examples should not be construed to limit any of the embodiments described in the present specification including those pertaining to the method of adding an additional seat onto a stroller.

### Example 1

### Adding an Additional Seat onto a Single Stroller

Parents or guardians have one child. The parents or guardians purchase a single stroller, a stem mountable child seat, and a car seat to transport the child around. Two years later an additional child is born. The parents or guardians are now in need of a double stroller to transport both children around, but do not want the added expense of buying a double stroller. The parents or guardians purchase an attachment device as illustrated in FIG. 1 to connect the single stroller to a stem mountable seat, converting the single stroller into a double stroller, thus alleviating the need to purchase a double stroller.

### Example 2

### Converting a Double Stroller into a Triple Stroller

Parents have twin children. The parents purchase a double stroller, a stem mountable child seat, and two car seats to transport the children around. Two years later an additional child is born. The parents are limited on space due to the small apartment they live in. The parents cannot afford to lose their valuable space by adding another stroller to the already large area the double stroller is occupying. The parents purchase the accessory attachment device to connect the double stroller to a stem mountable seat, converting the double stroller into a triple stroller.

### Example 3

### Toolless Attachment

Parents have one child. The parents purchase a single stroller, a stem mountable child seat, and a car seat to transport the child around. Two years later an additional child is born. The parents do not have any tools to install a device nor can they afford a new double stroller. The parents purchase the accessory attachment device, which does not require any tools to install. The parents are able to slip the accessory attachment device into the head tube/headset assembly of the stroller and then strap it down to the stroller's frame with the anti-rotation appendages. Thus, alleviating the parents need to buy a double stroller.

### Example 4

### Quick Disconnect of Accessory Attachment Device

Parents or guardians have one child. The parents or guardians purchase a single stroller, a stem mountable child seat, and a car seat to transport the child around. Two years later an additional child is born. The parent or guardian only wants to take the older child with them to run errands and leaves the younger child with the other parent or guardian. The parents have the attachment device connecting the stroller and the mountable seat. The parents are able to quickly disconnect the stroller from the mountable seat, turning the double stroller back into a single stroller. Thus, allowing the parent to only take the one child in the single stroller without having to take a double stroller.

### Example 5

### Adding an Accessory onto the Stroller

Parents or guardians have one child. The parents or guardians purchase a single stroller, a stem mountable child seat, and a car seat to transport the child around. Two years later an additional child is born. The parents or guardians like to go on long runs or walks with their child. The child becomes bored of the run or walks, and becomes fussy causing the parents or guardians to cut short their run or walks. The child is usually entertained by the parents tablet, portable DVD player, MP3 player, or portable computer. The parents or guardians purchase the attachment device with the accessory adapter allowing them to attach a tablet, portable DVD player, MP3 player, or portable computer to the stroller. The parents or guardians are now able to walk or run longer, because the child is now entertained during the long walks and runs.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of the present disclosure, which is defined solely by the claims. Accordingly, embodiments of the present disclosure are not limited to those precisely as shown and described.

Some embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

Groupings of alternative embodiments, elements, or steps of the present disclosure are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the disclosure are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the disclosed embodiments (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present disclosure and does not pose a limitation on the scope of the embodiments otherwise claimed. No language in the present specification should be construed as indicating any non-claimed element essential to the practice of the disclosed embodiments.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present disclosure so claimed are inherently or expressly described and enabled herein.

All patents, patent publications, and other publications referenced and identified in the present specification are individually and expressly incorporated herein by reference in their entirety for the purpose of describing and disclosing, for example, the compositions and methodologies described in such publications that might be used in connection with the disclosed embodiments. These publications are provided solely for their disclosure prior to the filing date of the present application. All statements as to the date or representation as to the contents of these documents is based on the information available to the applicant and does not constitute any admission as to the correctness of the dates or contents of these documents.

I claim:

1. An accessory attachment device for a wheeled seating device comprising:
an additional seat; and
an attachment device configured to attach the additional seat to the wheeled seating device.

2. The accessory attachment device of claim 1, further comprising:
a substantially stationary component;
a substantially rotating component; and
a headset.

3. The accessory attachment device of claim 2, wherein the wheeled seating device is a stroller.

4. The accessory attachment device of claim 2, wherein the wheeled seating device comprises a frame connected to a headset.

5. The accessory attachment device of claim 2, wherein the additional seat further comprises a seat support member.

6. The accessory attachment device of claim 2, wherein the substantially stationary component further comprises an attachment tube.

7. The accessory attachment device of claim 6, wherein the attachment tube further comprises at least one anti-rotation appendage configured to attach to the frame or to the headset.

8. The accessory attachment device of claim 2, further comprising a clamping mechanism.

9. The accessory attachment device of claim 5, further comprising a support tube configured to be releasably connected to the head tube, the seat support member, or both.

10. The accessory attachment device of claim 6, wherein the attachment tube is configured to support a seat support member.

11. The accessory attachment device of claim 10, wherein the seat support member is configured to connect to a mountable seat.

12. An accessory attachment device comprising:
a stroller;
a support member; and
an accessory attachment device;
wherein the support member is configured to attach the accessory attachment device to the stroller.

13. The accessory attachment device of claim 12, wherein the support member is configured to releasably attach the accessory attachment device to the stroller.

14. The accessory attachment device of claim 12, wherein the accessory attachment device is configured to be adjustable in the vertical direction, the horizontal direction, or a combination thereof.

15. The accessory attachment device of claim 12, wherein the accessory attachment device is configured to hold an accessory.

16. The accessory attachment device of claim 12, further comprising:
a substantially stationary component;
a substantially rotating component; and
a headset.

17. The accessory attachment device of claim 16, wherein the wheeled seating device comprises a frame connected to the headset.

18. The accessory attachment device of claim 16, wherein the accessory attachment device further comprises an accessory support member.

19. The accessory attachment device of claim 16, wherein the substantially stationary component further comprises an attachment tube including at least one anti-rotation appendage configured to attach to the frame or to the headset.

20. The accessory attachment device of claim 19, further comprising a support tube and a clamping mechanism, wherein the support tube is configured to be releasably connected to the head tube, the accessory support member, or both.
